(19) United States
(12) Patent Application Publication
(10) Pub. No.: US 2008/0066599 A1
(43) Pub. Date: Mar. 20, 2008

(54) Die cut punch with slots

(76) Inventors: Ronald Aniceto, Hawthorne, NJ (US); Amy Jane Reda, Piscataway, NJ (US)

Correspondence Address: SOFER & HAROUN LLP., 317 MADISON AVENUE, SUITE 910, NEW YORK, NY, 10017, US

(21) Appl. No.: 11/522,854

(22) Filed: Sep. 18, 2006

(51) Int. Cl. B26D 5/08

(52) U.S. Cl. 83/582; 83/627; 83/687

(57) ABSTRACT

A punch for making a decorative design in a sheet medium having a body formed with a fissure for receiving the sheet media, a cutter axially movable within the body and a die secured in the body for engaging with the cutter. The cutter has a first edge for cutting along at least a portion of a periphery of the decorative design, leaving at least another portion of the decorative design uncut. The cutter has at least one second edge within the first edge for cutting a second element within the decorative design, such that the resulting decorative design in the sheet media may be folded upwards from the sheet media along the portion of the decorative design cut by the first edge and where the portion of the design that is folded upward contains the second element cut by the second edge.

### FIELD OF THE INVENTION

The present invention relates to a punch device. More particularly, the present invention relates to a punch device for making a partial cutout in a sheet medium.

### BACKGROUND OF THE INVENTION

In the field of decorative crafts such as scrapbooking, one desired effect is to adorn a sheet medium with a design such as a heart or a butterfly that protrudes above the surface of the sheet medium for a three dimensional effect.

Creating such an effect using prior art devices and methods is a difficult process, requiring great skill in the use of hand blades, such as an X-ACTO® knife, to make the necessary incisions in the plane of the sheet medium without cutting through the surrounding area. Furthermore, following the precise outline of anything but the most basic of shapes is extremely difficult and time consuming by hand, which explains the lack of such designs in the prior art. Thus, there is a need for an invention which can produce consistently neat elaborate designs in a sheet medium and can be used an unlimited amount of times.

### SUMMARY OF THE INVENTION

The present invention provides a simple way to create an elaborate design in a sheet medium which protrudes above the surface of the sheet medium for producing a three dimensional effect. It is therefore an object of the present invention to provide a means for producing in a sheet medium a partial cutout with hollow interior portions. The partial cutout is created by making a perforation around a portion of the outer periphery of the design. The interior portions of the outer periphery can be raised above the surface of the sheet medium to produce a three-dimensional effect. The interior portions of the outer periphery each have at least one hollowed out portion, which is created by punching out entire shapes in the sheet medium.

It is a further object of the present invention to provide a punch device for creating such three dimensional designs including a seat body formed with a horizontal fissure and a vertical chamber communicated with the fissure. A cutting block is disposed in the chamber. One face of the cutting block is disposed with a cutter, while the other face of the cutting block is disposed with a channel passing through the cutting block. A pressing lever is pivotally disposed in the channel of the cutting block. A housing covers the seat body and is formed with a window for a pressing section of the pressing lever to extend therethrough. In use, a paper or a sheet is pushed into the fissure of the seat body and then the pressing section of the pressing lever is depressed to force the cutting block downward with the die punching the sheet medium placed in the fissure. Therefore, a partial cutout design with interior hollowed out portions is formed in the sheet medium.

It is a further object of the present invention to provide the above punch device, in which a resilient member is fitted under the cutting block in the chamber of the seat body. After the cutting block is released from the pressing force of the pressing lever, the resilient member serves to restore the cutting block to its home position.

It is still a further object of the present invention to provide the above punch device in which the cutting block is replaceably placed in the seat body, whereby the cutting block and die can be easily replaced by another cutting block and die to create different designs.

The present invention can be best understood through the following description and accompanying drawings, wherein:

### BRIEF DESCRIPTION OF THE DRAWINGS

The present invention can be best understood through the following description and accompanying drawings, wherein:

FIG. 1 is a perspective exploded view of the present invention, in accordance with one embodiment of the present invention;

FIG. 2 is a perspective assembled view of the present invention, in accordance with one embodiment of the present invention;

FIG. 3 is a front sectional view of the present invention, wherein the pressing lever is not pressed downward, in accordance with one embodiment of the present invention;

FIG. 4 is a side sectional view of the present invention, wherein the pressing lever is not pressed downward, in accordance with one embodiment of the present invention;

FIG. 5 is a side sectional view according to FIG. 4, wherein the pressing lever is pressed downward to punch the paper or the sheet, in accordance with one embodiment of the present invention;

FIG. 6 is a top-down view of the underside of cutting block 20, in accordance with one embodiment of the present invention;

FIG. 7 is an overhead view of female die 14, in accordance with one embodiment of the present invention;

FIG. 8 is an overhead view of the sheet medium after use with the present invention, in accordance with one embodiment of the present invention; and

FIG. 9 is a perspective view of the sheet medium from FIG. 8, in accordance with one embodiment of the present invention.

### DETAILED DESCRIPTION OF THE PREFERRED EMBODIMENT

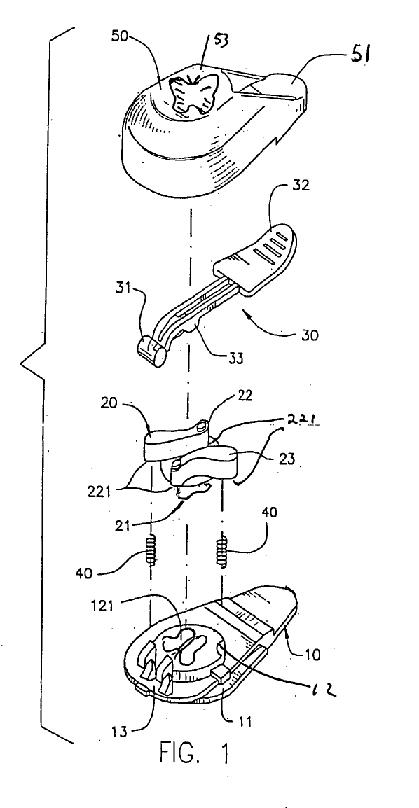

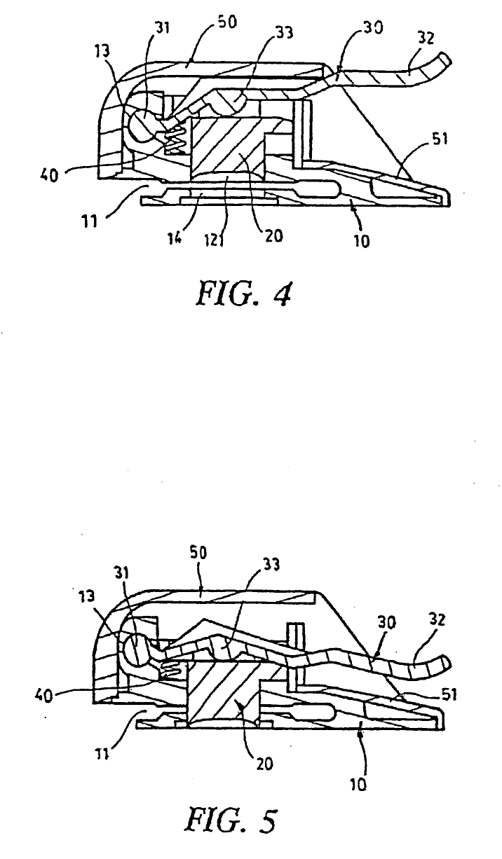

In one embodiment of the present invention, as illustrated in FIGS. 1 through 5, the punch device of the present invention includes a seat body 10 formed with a horizontal fissure 11 at one end and a vertical chamber 12. The bottom of the chamber 12 is formed with an opening 121 communicated with the fissure 11. An insertion cavity 13 is disposed on seat body 10 in front of opening 121. The bottom of the seat body 10 is formed with a female die 14 communicated with the fissure 11 opposite to the opening 121.

A cutting block 20 is disposed on the seat body 10. One face of the cutting block 20 facing the fissure 11 is disposed with a solid cutter 21 in the shape of the desired design such as a symmetrical shape. The present example of solid cutter 21 is in the shape of a butterfly, but any similar design is within the contemplation of the present invention. The other face of the cutting block 20 is disposed with a channel passing through the cutting block 20, forming walls 22 and 23.

The cutting block 20 is disposed with a projection 23 corresponding to the extension 122 to be fitted therein. A recess 221 is created on the underside of each of the protrusions of walls 22 and 23 for the purpose of engaging with resilient member 40, as described below.

A pressing lever 30 is disposed in the cutting block 20. One end of the pressing lever 30 is disposed with a pivot shaft 31 for rotatably inserting in the insertion cavity 13 of the seat body 10, whereby the pressing lever 30 is pivotally disposed on the seat body 10.

The other end of the pressing lever 30 is disposed with an upward bent pressing section 32. In addition, the pressing lever 30 is formed with a protuberance 33 extending in a direction reverse to that of the pressing section 32 for fitting in the recesses 221 of the cutting block 20.

At least one resilient member 40 is fitted into recess 221. As illustrated in FIG. 1, preferably two resilient members 40 are used where at least one resilient member 40 comprises first and second oppositely disposed springs adjacent to said die. The first resilient member 40 is disposed along a second axis and the second resilient member 40 disposed along a third axis, the third axis spaced apart from the first solid cutter 21 axis and the second resilient member 40 axis.

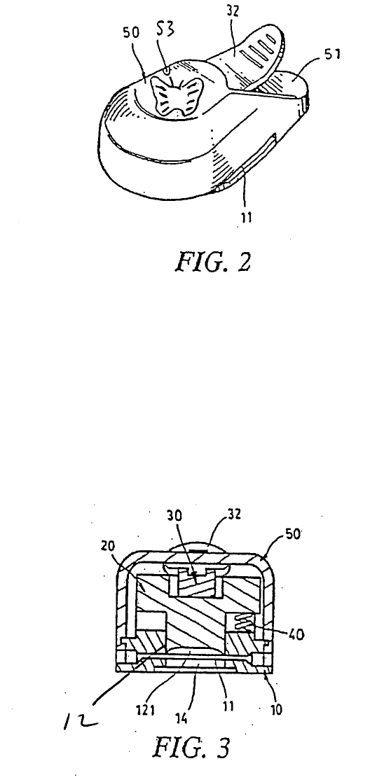

A housing 50 covers the seat body 10 and is formed with a window 51, whereby the pressing section 32 of the pressing lever 30 can extends through the window 51 out of the housing 50. As illustrated in FIGS. 1 and 2, housing 50 preferably maintains an indication 53 corresponding to the shape of cutter 21, in the present example, a butterfly.

In use, a paper or a sheet media 60 is horizontally placed in the fissure 11 of the seat body 10 and pushed inward to a true position. Fissure 11 is maintained perpendicular to the movement axis of cutter 21. Then the pressing section 32 of the pressing lever 30 is pivotally depressed about the pivot shaft 31, whereby the protuberance 33 of the pressing lever 30 is moved downward to exert a force onto the cutting block 20. Accordingly, the cutting block 20 is forced downward with the cutter 21 passing through the opening 121 of the chamber 12 to punch the paper or the sheet placed in the fissure 11 through the correspondingly shaped die 14. Thus, a perforation is created in the sheet medium as defined by the periphery of the cutter 21 which engages with the female die 14 as shown in FIG. 5 The resilient member 40 serves to restore the cutting block 20 to its home position. At this time, the pressing section 32 of the pressing lever 30 is moved upward along with the cutting block 20 to its home position. The above operation can be repeatedly performed to create the same partial cutout.

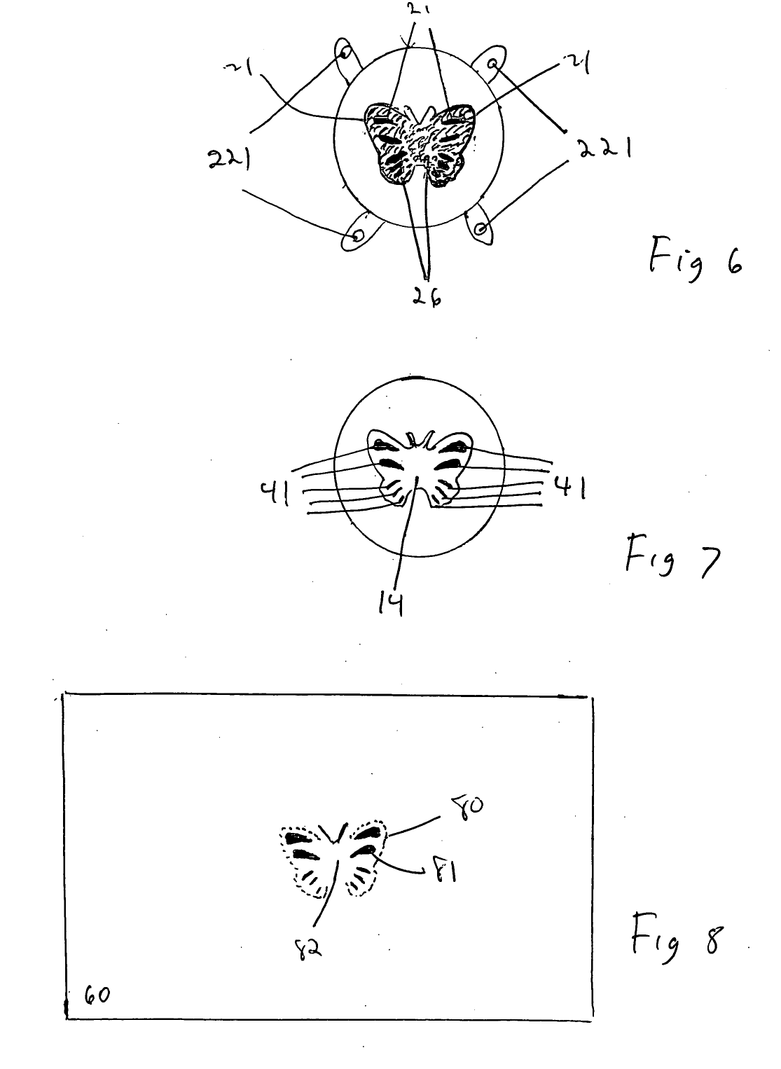

As shown in FIG. 6, cutter 21 is ideally a sharpened tapered metal blade, shaped as a three dimensional projection of the outline to be created. In one embodiment of the present invention, cutter 21 is tapered such that its highest point is furthest away from the vertical, or shorter, axis of the cutter. For example, in FIG. 6, cutter 21 is configured to cut deepest into sheet media 60 by the edges of the butterfly wings and is correspondingly configured to cut shallowest near the center longitudinal axis running along the same axis as lever 30.

In an alternate embodiment, the edge on cutter 21 can be serrated. Both approaches are designed to make the perforations for the cutouts as cleanly as possible, without any wrinkling or warping in the sheet medium 60. Cutter 21 may also be surrounded by a rubber or plastic insert 26, which is inserted into a recess in the center of the underside of cutting block 20. Insert 26 is used to make the perforations as cleanly as possible, without any wrinkling or warping of the sheet medium.

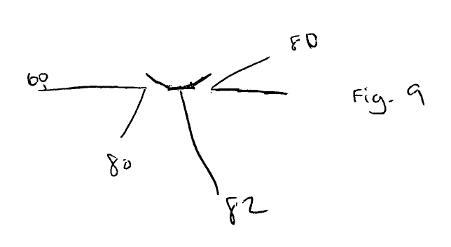

In one embodiment of the present invention, as illustrated in FIG. 7, die 14 is designed to engage with cutter 21 and is shaped as a female version of cutter 21. Die 14 is also equipped with a series of holes 41, through which the portions of the sheet medium which form holes 81 (FIG. 8) may be punched. A rubber or similar insert 42 may be placed into the recesses of die 14 to block all but the deepest portions of cutter 21 from entering die 14. This ensures that the perforations are made as precisely as possible.

As illustrated in FIG. 8, sheet medium 60 has been punched with the present invention. Sheet medium 60 can be made of paper, fabric, plastic, foil, or the like. Perforation 80 has been created by cutting along part of the outline of the desired design. As noted above cutter 21 is angled so that it cuts deepest away from the center longitudinal axis and shallowest near the center axis such that towards the center of the design sheet media is not cut at all along the outer edge as shown by element 82. In this arrangement, perforation 80 allows for a portion of the design to be bent upwards while also allowing the design to remain affixed to sheet media 60.

This allows for the portion of the design interior of perforation 80, to be bent upwards away from the plane of sheet media 60 to protrude from the surface creating a three dimensional effect. Holes 81 have been created by punching a portion of sheet medium 60 with cutter 21 through holes 41 in die 14. Both perforation 80 and holes 81 may be in any shape, and thus can create and two dimensional design. FIG. 9 shows a planar elevation view of FIG. 9 to better illustrate the wings of the butterfly design cut along perforation 80 in a raised from the plane of sheet media 60 for three dimensional effect.

It is to be understood that the above description and drawings are only used for illustrating one embodiment of the present invention, not intended to limit the scope thereof. Any variation and derivation from the above description and drawings should be included in the scope of the present invention.

1. A punch for making a decorative design in a sheet medium, said punch comprising:
a body formed with a fissure for receiving said sheet media,
a cutter axially movable within said body,
a die secured in said body configured to engage with said cutter,
wherein said cutter cuts has a first edge for cutting along at least a portion of a periphery of said decorative design, leaving at least another portion of said decorative design uncut, and wherein said cutter has at least one second edge within said first edge for cutting a second element within said decorative design, such that said resulting decorative design in said sheet media may be folded upwards from said sheet media along said portion of said decorative design cut by said first edge and wherein said portion of said design that is folded upward contains said second element cut by said second edge.

2. A punch as claimed in claim 1, wherein said decorative design is symmetrical along a longitudinal axis of said punch.

3. A punch as claimed in claim 2, wherein said first edge cuts along two portions of said periphery of said decorative design, distal to said center axis of said punch.

4. A punch as claimed in claim 3, wherein uncut portion of said periphery of said decorative design not cut by said first edge is proximal to said center axis of said punch.

5. A punch as claimed in claim 4, wherein said cutter maintains at least a third edge for cutting a third element within said decorative design, said third and second elements being disposed on different sides of the center axis of said punch.

6. A punch as claimed in claim 5, wherein said second and third elements are identical in shape and symmetrical about said center axis of said punch.
